(19) United States
(12) Patent Application Publication
(10) Pub. No.: US 2026/0153348 A1
(43) Pub. Date: Jun. 4, 2026

(54) NAVIGATION GUIDANCE METHOD AND A SYSTEM FOR SMOOTH PASSAGE THROUGH JUNCTION

(71) Applicant: HYUNDAI AUTOEVER CORP., Seoul (KR)

(72) Inventors: Ye Won Seol, Seoul (KR); Nam Ji Bang, Seoul (KR); Hee Eun Lee, Seoul (KR); Jung Yong Kim, Seoul (KR); Yeon Su Kim, Seoul (KR); Da Eun Joung, Seoul (KR)

(73) Assignee: HYUNDAI AUTOEVER CORP., Seoul (KR)

(21) Appl. No.: 19/352,261

(22) Filed: Oct. 7, 2025

(30) Foreign Application Priority Data
Dec. 4, 2024 (KR) 10-2024-0178734

(51) Int. Cl. G01C 21/36

(52) U.S. Cl. CPC G01C 21/3658; G01C 21/3691

(57) ABSTRACT

A navigation guidance method performed by a navigation system includes comparing a target lane for passing through a junction with a current lane and determining, based on a result of the comparison, whether a lane change is necessary. The navigation guidance method also includes identifying real-time traffic conditions and determining, based on the identified real-time traffic conditions, whether the lane change is possible. navigation guidance method additionally includes, in response to a determination that the lane change is not possible, providing guidance on an alternative route.

### CROSS-REFERENCE TO RELATED APPLICATION

This application claims the benefit of and priority to Korean Patent Application No. 10-2024-0178734, filed on Dec. 4, 2024, the entire contents of which are hereby incorporated herein by reference.

### TECHNICAL FIELD

The present disclosure relates to a lane change guidance method and system for a navigation device.

### BACKGROUND

A navigation system is widely used as a device that guides a driver to effectively reach a destination. The navigation system generally calculates an optimal route based on map data and real-time traffic information and provides route information to the driver through visual and/or voice guidance.

Recently, functions that utilize dynamic data such as real-time traffic conditions to avoid congestion or propose more efficient routes have been added. In addition, technologies have also been developed to guide drivers to change lanes or enter specific roads depending on specific road conditions or traffic regulations.

However, current navigation systems may fail to provide appropriate guidance for lane change timing and alternative routes based on real-time traffic conditions, which may cause confusion at junctions or negatively affect traffic safety. For example, when lane change guidance that considers traffic conditions is insufficient, drivers may experience confusion at junctions, which is problematic.

The statements in this Background section merely provide background information related to the present disclosure and may not constitute prior art.

### SUMMARY

Aspects of the present disclosure provide a lane change guidance method and system for a navigation device that supports a driver in safely and efficiently reaching a target lane by providing an alternative route when a lane change to pass through a branching point is delayed or difficult due to traffic conditions, or by providing lane change information at an appropriate time in consideration of traffic conditions.

Aspects of the present disclosure provide a method and system that support a driver in safely reaching a destination by guiding an alternative route when a lane change is delayed or impossible due to traffic conditions.

Aspects of the present disclosure provide a method and system that support a driver in efficiently reaching a target lane under traffic congestion by determining the timing for a lane change based on real-time traffic conditions and providing the timing to the driver.

Aspects of the present disclosure provide a method and system that offer more sophisticated and context-aware guidance to the driver by comprehensively considering traffic conditions and the congestion level of lanes in the process of determining and guiding a lane change.

The objectives of the present disclosure are not limited to those mentioned above. Other objectives not explicitly stated herein should be more clearly understood by those having ordinary skill in the art from the following description.

According to an aspect of the present disclosure, a navigation guidance method is provided. The navigation guidance method may be performed by a navigation system. The navigation guidance method includes comparing a target lane for passing through a junction with a current lane and determining, based on a result of the comparison, whether a lane change is necessary; identifying real-time traffic conditions and determining, based on the identified real-time traffic conditions, whether the lane change is possible. The navigation method also includes, in response to a determination that the lane change is not possible, providing guidance on an alternative route.

Providing the guidance on the alternative route may include providing the guidance on the alternative route before passing through the junction.

Providing the guidance on the alternative route may include providing the guidance on the alternative route a predetermined time after the determination that the lane change is not possible.

Determining whether the lane change is possible may include determining whether the lane change is possible based on a difference between the target lane and the current lane or a congestion level of the target lane.

Determining whether the lane change is possible may include comprehensively determining whether the lane change is possible by applying a weight to a difference between the target lane and the current lane or to a congestion level of the target lane.

According to another aspect of the present disclosure, a navigation guidance method is provided. The navigation guidance method may be performed by a navigation system. The navigation guidance method includes comparing a target lane for passing through a junction with a current lane and determining, based on a result of the comparison, whether a lane change is necessary. The method also includes, in response to a determination that the lane change is necessary, identifying real-time traffic conditions and determining, based on the identified real-time traffic conditions, a timing for the lane change. and providing lane change information including lane change timing information to an occupant.

Determining the lane change timing may include determining the lane change timing based on a difference between the target lane and the current lane or a congestion level of the target lane.

Determining the lane change timing may include comprehensively determining the lane change timing by applying a weight to a difference between the target lane and the current lane or to a congestion level of the target lane.

According to another aspect of the present disclosure, a navigation guidance system is provided. The navigation system includes at least one processor; and a memory storing computer-readable instructions executable by the at least one processor. The computer-readable instructions, when executed by the at least one processor, cause the at least one processor to compare a target lane for passing through a junction with a current lane and determine, based on a result of the comparison, whether a lane change is necessary. The computer-readable instructions, when executed by the at least one processor, also cause the at least one processor to identify real-time traffic conditions and determine, based on the identified real-time traffic conditions, whether the lane change is possible. The computer-readable instructions, when executed by the at least one processor, additionally cause the at least one processor to, in response to determining that the lane change is not possible, provide guidance on an alternative route.

The computer-readable instructions, when executed by the at least one processor, cause the at least one processor to provide the guidance before passing through the junction.

The computer-readable instructions, when executed by the at least one processor, cause the at least one processor to provide the guidance on the alternative route a predetermined time after the determination that the lane change is not possible.

The computer-readable instructions, when executed by the at least one processor, cause the at least one processor to determine whether the lane change is possible based on a difference between the target lane and the current lane or a congestion level of the target lane.

The computer-readable instructions, when executed by the at least one processor, cause the at least one processor to comprehensively determine whether the lane change is possible by applying a weight to a difference between the target lane and the current lane or to a congestion level of the target lane.

According to another aspect of the present disclosure, a navigation guidance method is provided. The navigation guidance method may be performed by a navigation system. The navigation guidance method includes comparing a target lane for passing through a junction with a current lane and determining, based on a result of the comparison, whether a lane change is necessary. The navigation guidance method also includes, in response to a determination that the lane change is necessary, identifying real-time traffic conditions and determining, based on the identified real-time traffic conditions, a timing for the lane change. The navigation guidance method additionally includes providing lane change information including lane change timing information to an occupant.

Determining the lane change timing may include determining the lane change timing based on a difference between the target lane and the current lane or a congestion level of the target lane.

Determining the lane change timing may include comprehensively determining the lane change timing by applying a weight to a difference between the target lane and the current lane or to a congestion level of the target lane.

It should be noted that the effects of the present disclosure are not limited to those described above. Other effects of the present disclosure not mentioned herein should be more apparent from the following description.

### BRIEF DESCRIPTION OF THE DRAWINGS

The above and other aspects and features of the present disclosure should become more apparent by from the following detailed description taken in conjunction with the accompanying drawings, in which:

FIG. 1 is a diagram illustrating a navigation system (a navigation guidance system) according to an embodiment of the present disclosure;

FIG. 2 is a diagram illustrating a navigation screen in a mobility device according to an embodiment of the present disclosure;

FIG. 3 is a diagram illustrating lane change guidance displayed on the navigation screen according to an embodiment of the present disclosure;

FIG. 4 is a diagram illustrating a junction displayed on the navigation screen according to an embodiment of the present disclosure;

FIG. 5 is a diagram illustrating situations where a lane change is possible or impossible according to an embodiment of the present disclosure;

FIG. 6 is a diagram illustrating an existing route and an alternative route according to an embodiment of the present disclosure;

FIG. 7 is a diagram showing various lane change guidance phrases according to an embodiment of the present disclosure;

FIG. 8 is a flowchart illustrating the overall process related to providing lane change guidance or alternative route guidance according to an embodiment of the present disclosure;

FIG. 9 is a flowchart illustrating the step-by-step process of providing alternative route guidance according to an embodiment of the present disclosure;

FIG. 10 is a flowchart illustrating the step-by-step process of providing lane change information according to an embodiment of the present disclosure; and

FIG. 11 is a block diagram illustrating the hardware configuration of a computing device that performs a navigation guidance method for smooth passage through a junction according to an embodiment of the present disclosure.

### DETAILED DESCRIPTION

Embodiments of the present disclosure are described in detail with reference to the accompanying drawings. The advantages and features of the present disclosure, and methods for achieving them, should become more clearly understood from the following detailed description of embodiments taken in conjunction with the accompanying drawings. However, the present disclosure is not limited to the embodiments described below and may be implemented in various different forms. The embodiments are provided only to ensure completeness of the present disclosure and to fully inform those having ordinary skill in the art of the scope of the present disclosure, and the present disclosure is defined only by the scope of the claims.

In assigning reference numerals to components in the drawings, it should be noted that the same reference numerals are used for the same components, as much as possible, even if the components appear in different drawings. In addition, in the present disclosure, detailed descriptions of related known components or functions has been omitted where it was determined that such descriptions would obscure the gist of the present disclosure.

Unless otherwise defined, all terms (including technical and scientific terms) used in this specification may be construed to have meanings commonly understood by one of ordinary skill in the art to which the present disclosure pertains. Terms that are generally defined in commonly used dictionaries should not be interpreted ideally or excessively unless explicitly defined otherwise. The terms used in this specification are intended to describe the embodiments and are not intended to limit the scope of the present disclosure. In this specification, the singular includes the plural unless specifically stated otherwise.

In addition, in describing the components of the present disclosure, terms such as first, second, A, B, (a), (b), and the like may be used. These terms are merely used to distinguish one component from another, and the nature, order, or sequence of the components is not limited by the terms. When it is stated that one component is “connected,” “coupled,” or “joined” to another component, it should be understood that the component may be directly connected or joined to the other component, but one or more other components may also be “connected,” “coupled,” or “joined” in between them.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

As used in this specification, the terms “comprises” and/or “comprising” do not exclude the presence or addition of one or more other components, steps, operations, and/or elements in addition to the ones mentioned.

Throughout the present disclosure, the term “mobility device” encompasses various types of vehicles that allow a driver or passenger to travel, and a representative example is an automobile with autonomous driving capabilities. Such a mobility device may autonomously travel to a destination or may adjust the driving route based on user input, and may select different driving modes depending on road conditions or driving environments. For example, an autonomous vehicle may recognize its surroundings in real time using sensors, cameras, LiDAR, and the like, and determine a route for safe driving. In addition, the term “mobility device” may also encompass personal mobility means such as electric scooters and bicycles.

Throughout the present disclosure, a “lane” refers to a space on a road in which a mobility device can drive in a single file. For example, lane 1 may refer to the lane adjacent to the centerline, lane 2 to the lane adjacent to lane 1, and lane 3 to the lane adjacent to lane 2. In the present disclosure, the terms “lane N” and “road lane N” may be used interchangeably with the same meaning. For example, the terms “lane 2” and “road lane 2” may be regarded as being equivalent to each other, and may be interpreted equivalently depending on the context.

Throughout the present disclosure, traffic congestion level may refer to a concept identifiable based on vehicle density or traffic volume data per lane.

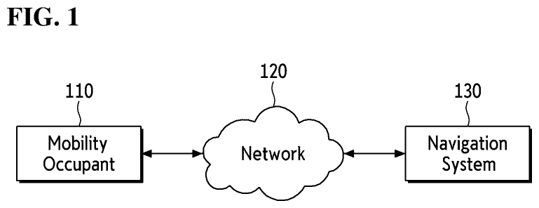

FIG. 1 is a diagram illustrating a navigation system (navigation guidance system) according to an embodiment of the present disclosure.

A mobility occupant 110 is a person who may use navigation guidance and may be provided with navigation guidance through an in-vehicle digital device or mobile device. The mobility occupant 110 may be connected to (e.g., using the in-vehicle digital device or the mobile device) a navigation system 130 via a network 120 to receive various guidance such as voice guidance and route information in real time. The mobility occupant 110 may include, for example, a driver or a passenger.

The network 120 is a communication network that enables data communication between the mobility occupant 110 and the navigation system 130 (e.g., using the in-vehicle digital device or the mobile device). The network 120 may include various wired and wireless communication technologies such as a wireless communication network, mobile communication network, and Wi-Fi, and may support data transmission between the mobility occupant 110 and the navigation system 130 (e.g., e.g., using the in-vehicle digital device or the mobile device), enabling real-time delivery of voice guidance and driving-related information.

The navigation system 130 may be a system that performs route guidance based on a request received from the mobility occupant 110 and/or data transmitted via the network 120. The navigation system 130 may provide necessary driving information based on the current location and route of the mobile occupant 110. The navigation system 130 may also identify the current lane of the mobility device and a target lane for passing through a junction. Based on a comparison between the current lane and the target lane, the navigation system 130 may inform the mobility occupant 110 of the need to change lanes. In some cases, if the navigation system 130 determines that a lane change is currently necessary but involves a risk due to congestion or other factors, the navigation system 130 may provide guidance on an alternative route to the mobility occupant 110. The mobility occupant 110 may then perform a safe lane change or follow the alternative route according to the guidance provided.

The navigation system 130 may interact with the mobility occupant 110 in real time through the network 120 and may constitute a system that provides an optimal driving experience to the mobility occupant 110.

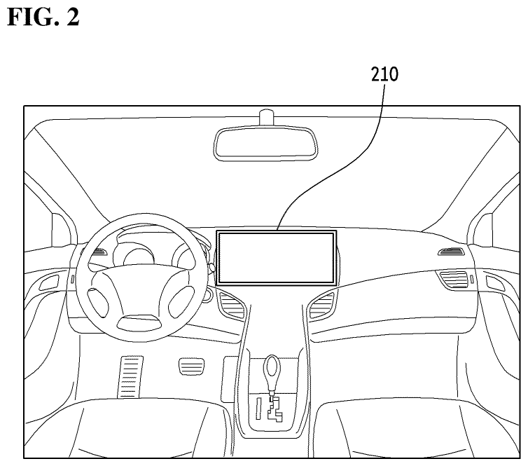

FIG. 2 is a diagram illustrating a navigation screen in a mobility device according to an embodiment of the present disclosure.

A navigation screen 210, which may be a display installed at the center of the interior of mobility device, may be configured to allow a driver or passenger to check driving-related information in real time. The navigation screen 210 may provide various functions such as map and route guidance and traffic condition display and may be implemented as a touch display for an intuitive user experience.

The driver may check a target route and lane change information or explore an alternative route depending on the traffic condition through the navigation screen 210. Additionally, the navigation screen 210 may display information relevant to the driving situation in a popup form to help avoid visual distraction during driving.

In some embodiments, the navigation screen 210 may include a voice guidance function and may provide the driver with necessary information in real time, such as route changes or lane change timing. The navigation screen 210 may also include a function that recognizes voice input from the driver or passenger and/or analyzes external and internal noise to optimize guidance information.

Such a design may be implemented to enhance safety and user convenience within the mobility device.

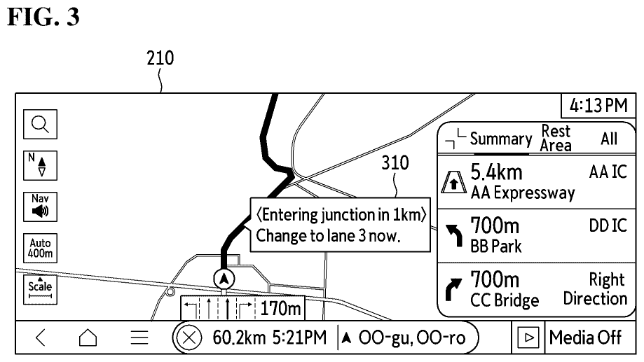

FIG. 3 is a diagram illustrating lane change guidance displayed on the navigation screen according to an embodiment of the present disclosure.

The navigation screen 210 may display in real time the current location and driving route of the mobility device, and information related to lane change. Visual and textual information related to the driving route may be provided so that the driver or passenger may intuitively understand necessary information.

A route change guidance phrase 310 may provide the driver with information on a necessary lane change to pass through a specific junction. For example, a phrase such as “<Entering junction in 1 km> Change to lane 3 now” may guide the driver to change lanes at the appropriate time. This phrase may include key information such as the distance to the junction, the target lane, and the need for lane change, and may be displayed in an appropriate area of the navigation screen 210. In some embodiments, color, sound, or animation may be used to emphasize the delivery of information.

According to an embodiment, the navigation guidance system of the present disclosure may provide real-time guidance for optimal lane change time, avoiding overly early or late changes. For example, overly early lane change guidance may lead to unnecessary route changes and increase the time required to reach the destination, while overly late guidance may cause safety issues due to abrupt lane changes. To minimize such problems, the navigation guidance system of the present disclosure may analyze real-time traffic conditions and the speed of the mobility device to provide lane change information to the driver at an appropriate time.

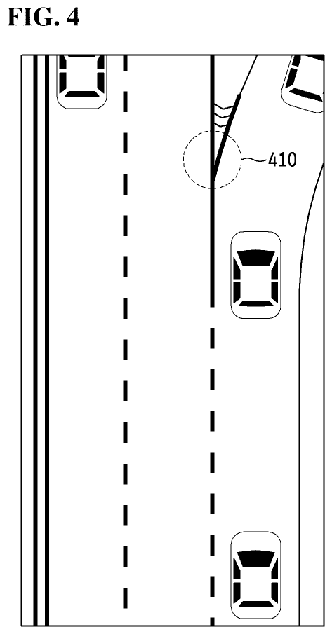

FIG. 4 is a diagram illustrating a junction displayed on the navigation screen according to an embodiment of the present disclosure.

A junction 410 indicates a point where an existing road may connect to another road. In the present disclosure, a junction may refer to a place where a left or right turn must be made at an intersection, an exit at a roundabout, or an entrance or exit section of a highway or expressway.

To smoothly pass through a junction, a lane change may be necessary. Typically, it may be desirable for a lane change to occur within N meters before a junction. This is because junction areas are often congested due to high vehicle traffic. If a lane change or merging is attempted abruptly in a congested junction, the risk of accidents may increase.

Therefore, in order to reduce the risk of accidents, the driver may be guided to change lanes in advance before reaching a junction. If a lane change is difficult or impossible, the navigation guidance system of the present disclosure may provide an alternative route to support safe and efficient driving.

Such a design may contribute to improving driver safety and reducing accidents and confusion that may occur when passing through a junction.

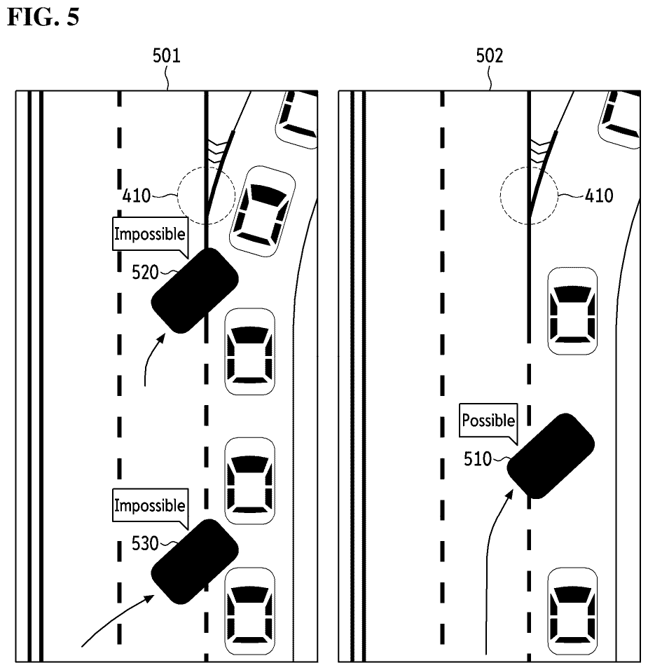

FIG. 5 is a diagram illustrating situations in which a lane change is possible or not possible according to an embodiment of the present disclosure.

FIG. 5 illustrates an example where traffic congestion, the physical distance between lanes, and the distance from a lane change point to a junction 410 are considered in a situation where a lane change is required to pass through the junction 410.

The right diagram 502 exemplifies a situation in which a lane change is possible. A first vehicle 510 traveling in lane 2 needs to change to lane 3 to pass through the junction 410. Traffic congestion near the junction 410 is low, and the difference between the current lane and the target lane is only one lane, which is not significant. In addition, the distance from the lane change point to the junction 410 is sufficiently secured, enabling a lane change to be performed without difficulty.

Conversely, the left diagram 501 exemplifies a situation in which a lane change is not possible.

A second vehicle 520 traveling in lane 2 needs to change to lane 3 to pass through the junction 410. Although the difference between the current lane and the target lane is only one lane, the distance from the lane change point to the junction 410 is short, and traffic congestion is high, making it difficult to change lanes. If a lane change is attempted forcibly, the risk of an accident may increase. In this case, it may be determined that a lane change by the second vehicle 520 is not possible.

A third vehicle 530 traveling in lane 1 needs to change to lane 3. Although the distance from the lane change point to the junction 410 is relatively long, the difference between the current lane and the target lane is two lanes, which is relatively considerable. In addition, due to high traffic congestion, it is difficult to safely change lanes. In this case, considering both the distance between lanes and the level of congestion, it may be determined that the third vehicle 530 is unable to change lanes.

In the present disclosure, the difference between the current lane and the target lane may encompass the difference in the number of lanes or the physical distance between lanes.

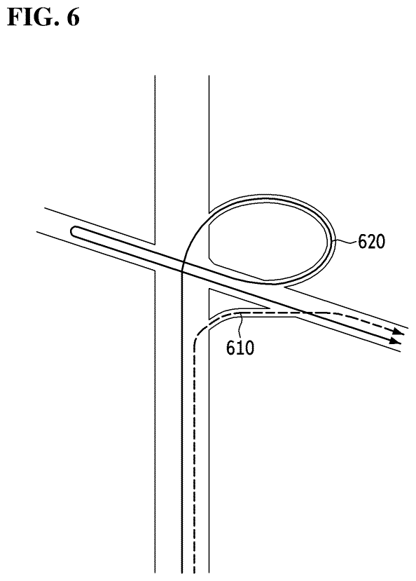

FIG. 6 is a diagram illustrating an existing route and an alternative route according to an embodiment of the present disclosure.

A first route 610 and a second route 620 represent routes that branch to the right via a first junction and a second junction, respectively.

The first route 610 may be an existing route that branches to the right via the first junction. Generally, if a driver fails to branch at the first junction while following the first route 610 and passes the first junction, the navigation guidance system of the present disclosure may recognize this and guides the driver to the second route 620, a detour branching at the second junction.

According to an embodiment of the present disclosure, if it is determined that a lane change at the first junction is not possible, the navigation system may guide the driver to the second route 620, an alternative route, even before passing the first junction. This may be for the purpose of preventing a forced entry attempt in a situation where a lane change is impossible and providing a safe route.

In addition, after determining that a lane change is impossible, the navigation system may guide the second route 620 as an alternative route within a predetermined time. For example, when the navigation system determines that changing to the target lane is impossible by comprehensively considering traffic congestion, the difference between the current lane and the target lane, and the distance between the current position and the first junction, the navigation system may guide the user to follow the second route 620, the detour route, within five seconds. This may help the driver select a safe route in a timely manner.

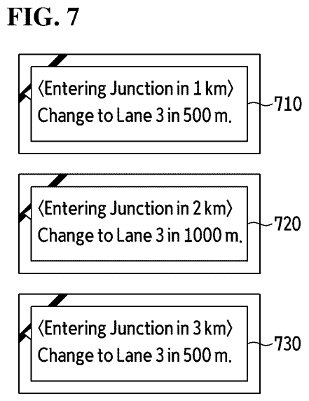

FIG. 7 is a diagram illustrating various lane change guidance phrases according to an embodiment of the present disclosure.

The navigation guidance system of the present disclosure may comprehensively consider traffic congestion, distance to a junction, and the difference between the current lane and the target lane to determine when to provide guidance before the mobility vehicle enters the junction. Through this, the driver may be provided with a safer and more optimized driving experience.

The guidance phrases shown in FIG. 7 may be configured to be intuitively understandable to the driver while driving and may include specific instructions for lane change. The guidance phrases may clearly present information such as the distance to the junction, the location where the lane change should occur, and the target lane.

A first guidance phrase 710 includes a message that reads “<Entering junction in 1 km> Change to lane 3 in 500 m.” The first guidance phrase 710 informs that the junction is 1 km ahead and provides guidance that a lane change is appropriate 500 m from the current position. The first guidance phrase 710 may be provided in a situation where traffic congestion is low and lane change is relatively easy.

A second guidance phrase 720 includes a message that reads “<Entering junction in 2 km>Change to lane 3 in 1000 m.” The second guidance phrase 720 indicates that the junction is 2 km ahead and provides guidance to prepare for a lane change 1000 m from the current position. In a driving situation where there is ample distance to the junction, this may help the driver plan and perform a lane change sufficiently in advance.

A third guidance phrase 730 includes a message that reads “<Entering junction in 3 km> Change to lane 3 in 500 m.” This message informs that the junction is 3 km ahead and guides the driver to start a lane change 500 m ahead from the current position. The third guidance phrase 730 may be provided in a situation where lane change is relatively difficult, such as when traffic congestion is high or the difference between the current lane and the target lane is large. This may help ensure safety by guiding the driver to prepare for a lane change in advance.

In this manner, the navigation guidance system of the present disclosure may generate an optimized guidance phrase by comprehensively analyzing a variety of variables to help the driver safely and efficiently pass through a junction. The guidance phrase may clearly present the distance to the junction, the appropriate timing for lane change, and the target lane to be changed to, thereby minimizing confusion and contributing to the creation of a safe driving environment.

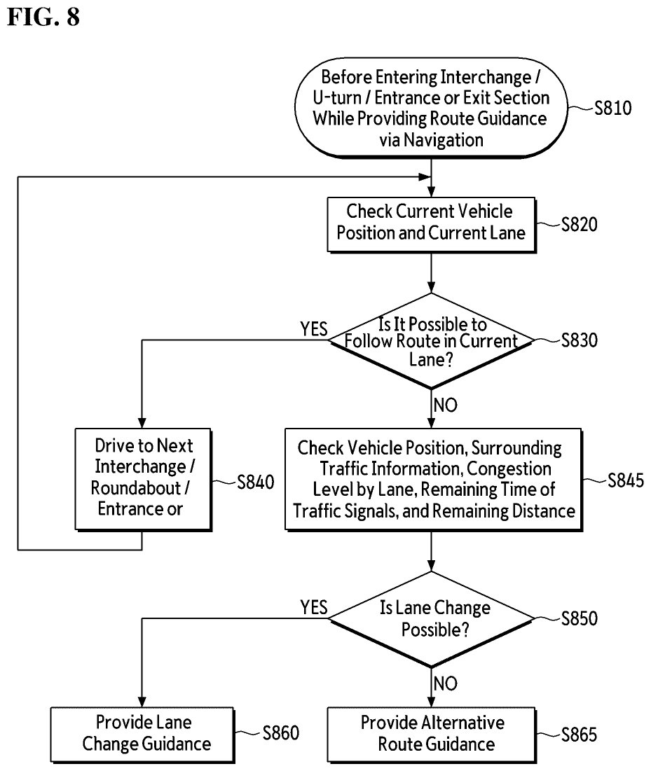

FIG. 8 is a flowchart illustrating an overall process related to providing lane change guidance or alternative route guidance according to an embodiment of the present disclosure.

The flowchart in FIG. 8 may specifically describe a method for providing lane change guidance and alternative route guidance so that the driver can safely and efficiently pass through a specific junction such as an intersection, curved section, or entry/exit section.

In step or operation S810, it may be determined that a mobility device for which route guidance is in progress via the navigation guidance system of the present disclosure has reached a location N km ahead of an intersection, curved section, or entry/exit section. Step or operation S810 is an initial step for starting route guidance, and the navigation system may identify the current position of the mobility device and the distance to the junction.

In step or operation S820, the current position and the current lane of the mobility device may be identified. In step or operation step S820, information may be acquired to analyze which lane the mobility device is currently traveling in and whether the current lane is suitable for route guidance.

In step or operation S830, it may be determined whether it is possible to continue traveling along the driving route from the current lane. If it is determined that travel is possible from the current lane, the process may proceed to step or operation S840 to continue driving to the junction. However, if it is determined that travel along the driving route is not possible from the current lane, the process may proceed to step or operation S845.

In step or operation S845, the location of the mobility device, surrounding traffic information, congestion level by lane, remaining signal time, and remaining distance to the junction may be comprehensively analyzed. In step or operation S845, data may be collected and analyzed to determine whether a lane change is possible under the current conditions.

In step or operation S850, based on the data acquired in step or operation S845, it may be determined whether a lane change is possible. If it is determined that a lane change is possible, the process may proceed to step or operation S860 to provide appropriate lane change guidance. The lane change guidance may be optimized so that the mobility device may pass through the junction smoothly.

Meanwhile, if it is determined in step or operation S850 that a lane change is not possible, the process may proceed to step or operation S865 to provide guidance on an alternative route. The alternative route may include a detour route designed to guide the driver safely and efficiently to the destination in a situation where the junction cannot be passed.

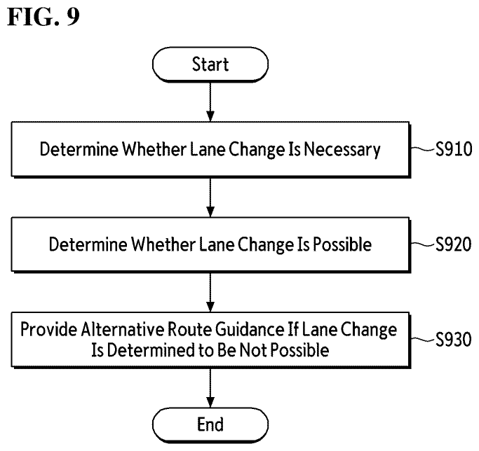

FIG. 9 is a flowchart illustrating the step-by-step process of providing alternative route guidance according to an embodiment of the present disclosure.

In step or operation S910, the navigation guidance system of the present disclosure may determine whether a lane change is necessary. The navigation system may analyze the current position and current lane of a mobility device, and the difference from a target lane to identify whether a lane change is needed to pass through a junction or follow a specific route. If it is identified that a lane change is not necessary, the navigation system may guide the driver to continue driving in the current lane without proceeding to step or operation S920.

In step or operation S920, the navigation system may determine whether a lane change is possible. The navigation system may comprehensively consider various factors such as the difference between the current lane and the target lane, the level of vehicle congestion, and the remaining distance to the junction to determine whether a lane change is possible. By determining the possibility of a lane change, the navigation system may help prevent forced lane change attempts, thereby ensuring driver safety.

In relation to step or operation S930, when it is determined that a lane change is not possible, the navigation system may provide guidance on an alternative route. For example, the navigation system may analyze the speed of the mobility device, the number of lanes, the remaining time of traffic signals, the level of traffic congestion, and the driving routes of surrounding mobility devices to calculate an alternative route in real time. The navigation system may calculate and design the alternative route in real time to minimize the time to reach the destination while not significantly deviating from the original driving route. In the process of selecting the alternative route, whether the variation in estimated arrival time is minimal may also be considered. The driver may continue driving stably along the alternative route instead of attempting a risky lane change.

In relation to the embodiment of FIG. 9, the navigation system may analyze the driver's current position and traffic conditions in real time and, through the provision of an alternative route, may minimize unnecessary confusion for the driver and provide an efficient and safe driving environment.

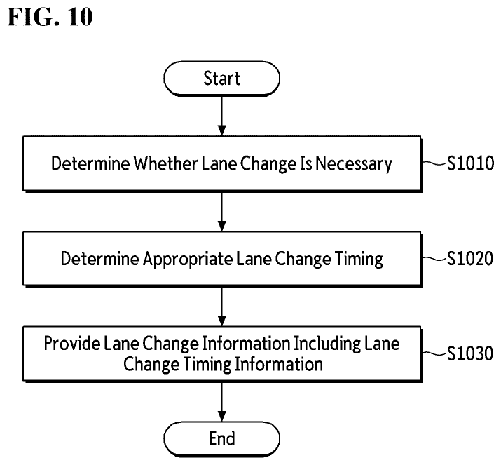

FIG. 10 is a flowchart illustrating the step-by-step process of providing lane change information according to an embodiment of the present disclosure.

According to an embodiment related to FIG. 10, the navigation guidance system of the present disclosure may determine an appropriate timing and provide guidance so that the driver or mobility occupant of a mobility device may perform a lane change safely and efficiently, thereby improving driving safety.

In step or operation S1010, the navigation system may determine whether a lane change is necessary. Specifically, the navigation system may analyze the current position and driving route of the mobility device and the difference between the target lane and the current lane of the mobility device to identify the need for a lane change. If it is determined that a lane change is not necessary, the navigation system may guide the driver to continue driving in the current lane without proceeding to step or operation S1020.

In step or operation S1020, the navigation system may determine an appropriate timing for a lane change. The navigation system may comprehensively consider various information such as the difference between the current lane and the target lane, the distance to the junction, surrounding traffic conditions, and vehicle speed to determine an optimal timing for the lane change. This determination may help prevent forced lane change attempts and ensure driver safety, and may also prevent delays in the estimated arrival time that may occur due to overly late lane changes.

In step or operation S1030, the navigation system may provide lane change information including the appropriate timing for the lane change. The navigation system may clearly present the specific timing required for the lane change along with the target lane. Through such guidance, the driver may prepare in advance for the lane change and safely perform the lane change.

In relation to the embodiment of FIG. 10, the navigation system may analyze the driver's current position and traffic conditions in real time and provide optimal lane change timing information, thereby establishing a safe driving environment. Such guidance may reduce confusion for the driver and enable efficient and stable driving.

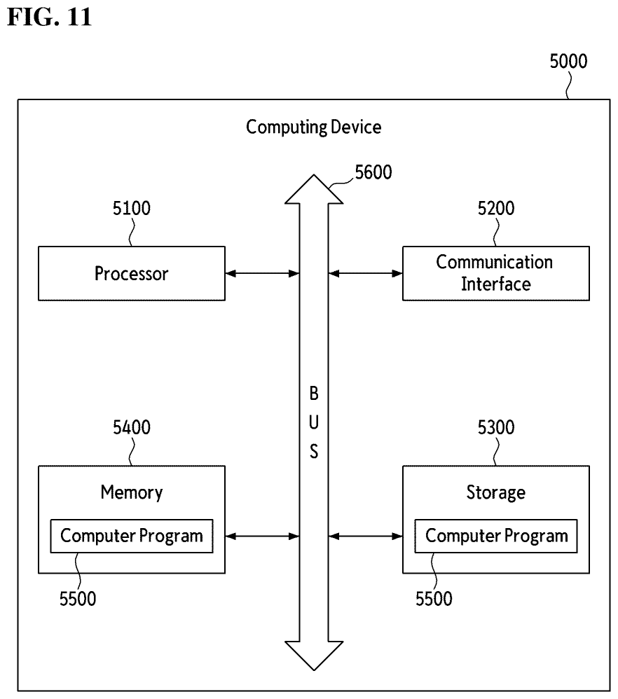

FIG. 11 is a block diagram illustrating the hardware configuration of a computing device for navigation voice guidance according to an embodiment of the present disclosure.

Referring to FIG. 11, a computing device 5000 may include at least one processor 5100, a bus 5600, a communication interface 5200, a memory 5400 that loads a computer program 5500 executed by the processor 5100, and a storage 5300 that stores the computer program 5500. It is noted that only components relevant to the embodiments of the present disclosure are illustrated in FIG. 11.

Therefore, one of ordinary skill in the art should understand that the computing device 5000 may include additional general components beyond those illustrated in FIG. 11. That is, the computing device 5000 may include various additional components other than those depicted in FIG. 11. Also, in some embodiments, some components in FIG. 11 may be omitted from the configuration of the computing device 5000. Below is a description of each component of the computing device 5000, according to an embodiment. In addition, throughout the present disclosure, the terms “computing device” and “computing system” may be used interchangeably.

The processor 5100 may control the overall operation of each component of the computing device 5000. The processor 5100 may include at least one of a central processing unit (CPU), a micro processing unit (MPU), a micro controller unit (MCU), a graphics processing unit (GPU), or any processor form well known in the technical field of the present disclosure. The processor 5100 may perform computations for at least one application or program that executes operations/methods according to various embodiments of the present disclosure. The computing device 5000 may include more than one processor.

The memory 5400 may store various data, commands, and/or information. To execute the operations/methods according to various embodiments of the present disclosure, the memory 5400 may load the computer program 5500 from the storage 5300. The memory 5400 may be implemented as volatile memory such as RAM, but the present disclosure is not limited thereto.

The bus 5600 may provide a communication function between the components of the computing device 5000. The bus 5600 may be implemented in various forms such as an address bus, data bus, and control bus.

The communication interface 5200 may support wired or wireless Internet communication of the computing device 5000. Also, the communication interface 5200 may support various communication methods other than Internet communication. To this end, the communication interface 5200 may include communication modules well known in the technical field of the present disclosure.

The storage 5300 may non-transitorily store one or more computer programs 5500. The storage 5300 may include nonvolatile memory such as ROM, EPROM, EEPROM, flash memory, hard disk, removable disk, or any form of computer-readable recording medium well known in the technical field of the present disclosure.

The computer program 5500 may include one or more instructions that, when loaded into the memory 5400, cause the processor 5100 to perform the operations/methods according to various embodiments of the present disclosure. That is, the processor 5100 may perform the operations/methods according to various embodiments of the present disclosure by executing the loaded one or more instructions.

For example, the computer program 5500 may include computer-readable instructions for performing the operations of: comparing a target lane for passing through a junction with a current lane and determining, based on the result of the comparison, whether a lane change is necessary; identifying real-time traffic conditions and determining, based on the identified real-time traffic conditions, whether the lane change is possible; and in response to a determination that the lane change is not possible, providing alternative route guidance.

The navigation system of the present invention may exert various effects that maximize driving safety and convenience during driving by providing lane change and alternative route guidance in consideration of real-time conditions so that the driver can pass through a junction efficiently and safely. The main effects of the present invention are as follows.

First, the navigation system of the present disclosure may provide appropriate lane change information by analyzing in real time whether a lane change is necessary and possible, thereby enabling the driver to smoothly pass through a junction. Through this, the driver may drive safely without unnecessary confusion when approaching a junction and may appropriately respond even in the case of heavy traffic congestion.

Second, when it is determined that a lane change is not possible, the navigation system of the present disclosure may calculate and provide an alternative route in real time, thereby reducing the risk of accidents caused by forced lane changes. The alternative route may be designed to maintain similarity with the original driving route while minimizing the time to reach the destination, allowing the driver to continue driving stably and efficiently.

Third, the navigation system of the present disclosure may optimize the timing for lane change and route guidance by comprehensively considering various elements such as surrounding traffic conditions, vehicle congestion, and the remaining distance to the junction. Through this, the driver may avoid problems such as unnecessary delays in the estimated arrival time due to overly early lane changes or exposure to accident risks due to overly late lane changes.

Fourth, the navigation system of the present disclosure may minimize interference from unnecessary information during driving by providing the necessary information to the driver in a timely manner, thereby improving the clarity and efficiency of route guidance. For example, critical guidance such as important junction information may be provided preferentially, while less important information may be omitted or presented as needed.

Through these functions, the navigation system of the present disclosure may help the driver pass through a junction safely and efficiently and provide an environment that can flexibly respond to various situations that may occur during driving. As a result, the driver may maintain concentration during driving and reach the destination more conveniently and safely.

The various embodiments and effects of the present disclosure have been described above with reference to FIGS. 1-11. The effects according to the technical spirit of the present disclosure are not limited to those described above. Other effects not mentioned should be more clearly understood by one of ordinary skill in the art based on the above description.

Although all components constituting the embodiments of the present disclosure have been described as being combined into one or operating as one, the present disclosure is not necessarily limited to such embodiments. Within the scope of the objectives of the present disclosure, all components may selectively operate in combinations of one or more.

Although operations are illustrated in a specific order in the drawings, it should not be understood that the operations must be executed in the specific or sequential order shown, or that all the illustrated operations must be executed to obtain the desired result. In certain situations, multitasking and parallel processing may be advantageous. Furthermore, the separation of various configurations in the embodiments described above should not be understood as mandatory, and it should be understood that the described program components and systems can generally be integrated as a single software product or packaged as multiple software products.

Although the embodiments of the present disclosure have been described above with reference to the accompanying drawings, one of ordinary skill in the art should understand that the present disclosure may be embodied in other specific forms without changing the technical spirit or essential features. Therefore, the embodiments described above are to be understood in all respects as illustrative and not limiting. The scope of protection of the present disclosure should be interpreted based on the following claims, and all technical ideas within the equivalent scope should be construed as included in the scope of rights of the present disclosure.

What is claimed is:

1. A navigation guidance method performed by a navigation system, the navigation guidance method comprising:
comparing a target lane for passing through a junction with a current lane and determining, based on a result of the comparison, whether a lane change is necessary;
identifying real-time traffic conditions and determining, based on the identified real-time traffic conditions, whether the lane change is possible; and
in response to a determination that the lane change is not possible, providing guidance on an alternative route.

2. The navigation guidance method of claim 1, wherein providing the guidance on the alternative route includes providing the guidance on the alternative route before passing through the junction.

3. The navigation guidance method of claim 1, wherein providing the guidance on the alternative route includes providing the guidance on the alternative route a predetermined time after the determination that the lane change is not possible.

4. The navigation guidance method of claim 1, wherein determining whether the lane change is possible includes determining whether the lane change is possible, based on a difference between the target lane and the current lane or a congestion level of the target lane.

5. The navigation guidance method of claim 1, wherein determining whether the lane change is possible includes comprehensively determining whether the lane change is possible by applying a weight to a difference between the target lane and the current lane or to a congestion level of the target lane.

6. A navigation guidance method performed by a navigation system, the navigation guidance method comprising:
comparing a target lane for passing through a junction with a current lane and determining, based on a result of the comparison, whether a lane change is necessary;
in response to a determination that the lane change is necessary, identifying real-time traffic conditions and determining, based on the identified real-time traffic conditions, a timing for the lane change; and
providing lane change information including lane change timing information to an occupant.

7. The navigation guidance method of claim 6, wherein determining the lane change timing includes determining the lane change timing based on a difference between the target lane and the current lane or a congestion level of the target lane.

8. The navigation guidance method of claim 6, wherein determining the lane change timing includes comprehensively determining the lane change timing by applying a weight to a difference between the target lane and the current lane or to a congestion level of the target lane.

9. A navigation guidance system comprising:
at least one processor; and
a memory storing computer-readable executable by the at least one processor,
wherein the computer-readable instructions, when executed by the at least one processor, cause the at least one processor to:
compare a target lane for passing through a junction with a current lane and determining, based on a result of the comparison, whether a lane change is necessary,
identify real-time traffic conditions and determine, based on the identified real-time traffic conditions, whether the lane change is possible, and
in response to a determination that the lane change is not possible, provide guidance on an alternative route.

10. The navigation guidance system of claim 9, wherein the computer-readable instructions, when executed by the at least one processor, cause the at least on processor to provide the guidance before passing through the junction.

11. The navigation guidance system of claim 9, wherein computer-readable instructions, when executed by the at least one processor, cause the at least on processor to provide the guidance on the alternative route a predetermined time after the determination that the lane change is not possible.

12. The navigation guidance system of claim 9, wherein computer-readable instructions, when executed by the at least one processor, cause the at least on processor to determine whether the lane change is possible based on a difference between the target lane and the current lane or a congestion level of the target lane.

13. The navigation guidance system of claim 9, wherein the computer-readable instructions, when executed by the at least one processor, cause the at least on processor to comprehensively determine whether the lane change is possible by applying a weight to a difference between the target lane and the current lane or to a congestion level of the target lane.
